(19) United States
(12) Patent Application Publication
(10) Pub. No.: US 2003/0146632 A1
(43) Pub. Date: Aug. 7, 2003

(54) Snow removal tool

(76) Inventors: Tucker J. Marion, St. Davids, PA (US); Marvin I. Weinberger, Havertown, PA (US)

Correspondence Address: MENDELSOHN AND ASSOCIATES PC, 1515 MARKET STREET, SUITE 715, PHILADELPHIA, PA, 19102, US

(21) Appl. No.: 10/236,016

(22) Filed: Sep. 5, 2002

Related U.S. Application Data
(60) Provisional application No. 60/317,273, filed on Sep. 5, 2001.

(51) Int. Cl. A01B 1/22; E01H 5/02

(52) U.S. Cl. 294/51; 294/54.5

(57) ABSTRACT

A hand tool adapted to mechanically remove material such as snow from surfaces such as automobile exterior body or window glass surfaces includes a longitudinally-extending handle and a head that extends generally transversely to the handle and is secured to one end of the handle. The head includes a forward plow portion that is adapted to move material when the tool is pushed in a direction that is generally parallel to the handle, and includes a rear plow portion that is adapted to move material when the tool is pulled in the opposite direction.

### CROSS-REFERENCE TO RELATED APPLICATIONS

This nonprovisional U.S. national application, filed under 35 U.S.C. §111(a), claims, under 35 U.S.C. §119(e)(1), the benefit of the filing date of provisional U.S. national application No. 60/317,273 filed under 35 U.S.C. §111(b) on Sep. 5, 2001 as attorney docket no. 1046.007PROV, the teachings of which are incorporated herein by reference.

### BACKGROUND OF THE INVENTION

The present invention relates to hand tools adapted for use in removing materials such as snow from areas where such materials are not desired, for example, from exterior surfaces of automobiles.

### BRIEF SUMMARY OF THE INVENTION

Embodiments of hand tools adapted to mechanically remove material such as snow from surfaces such as automobile exterior body or window glass surfaces in accordance with the present invention include a longitudinally-extending handle and a head that extends generally transversely to the handle and is secured to one end of the handle, wherein the head includes a forward plow portion that is adapted to move material when the tool is pushed in a direction that is generally parallel to the handle, and includes a rear plow portion that is adapted to move material when the tool is pulled in the opposite direction.

### BRIEF DESCRIPTION OF THE DRAWINGS

The foregoing and other aspects, features, and advantages of the present invention will become more fully apparent from the following detailed description, the appended claims, and the accompanying drawings in which:

FIG. 1 is a top, front, left perspective view of a first embodiment of a snow removal tool according to the present invention, shown with its handle in a first configuration;

FIG. 2 is a right side elevational view of the first embodiment;

FIG. 3 is a top plan view of the first embodiment;

FIG. 4 is a bottom plan view of the first embodiment;

FIG. 5 is a front elevational view of the first embodiment;

FIG. 6 is a rear elevational view of the first embodiment;

FIG. 7 is a top, front, left perspective view of the first embodiment, shown with its handle in a second configuration;

FIG. 8 is a right side sectional view of the head of the first embodiment;

FIGS. 9A, 9B, and 9C illustrate the use of a snow removal tool according to the present invention;

FIG. 10 is a perspective illustration of a second embodiment of a snow removal tool according to the present invention;

FIG. 11 is a perspective illustration of a third embodiment of a snow removal tool according to the present invention;

FIG. 12 is a perspective illustration of a fourth embodiment of a snow removal tool according to the present invention;

FIG. 13A is a perspective illustration and FIG. 13B is a side view of a fifth embodiment of a snow removal tool according to the present invention; and

FIG. 14 is a perspective illustration of a sixth embodiment of a snow removal tool according to the present invention.

### DETAILED DESCRIPTION

In accordance with the present invention, a snow removal tool includes a longitudinally-extending member, referred to herein as a “handle,” having a head secured to one end of the handle. Embodiments of the invention may include a grip disposed at the other end of the handle. As used herein, a “grip” is a structure provided in order to be grasped by a user's hand, and a “handle” is the longitudinally extending structure that transmits applied force to the head. A grip may be provided to facilitate a user applying force to the snow removal tool in a direction generally parallel to the length of the handle to move the head along the surface to be cleared of snow or the like. The snow removal tool is adapted to mechanically remove materials such as snow from surfaces, such as automobile exterior body parts and/or window glass, when placed in contact with such a material and moved generally parallel to the handle and generally parallel to such a surface.

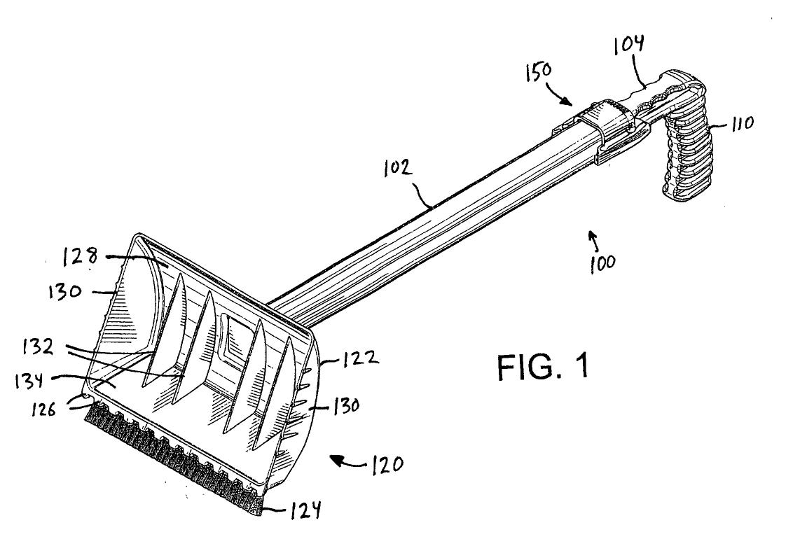

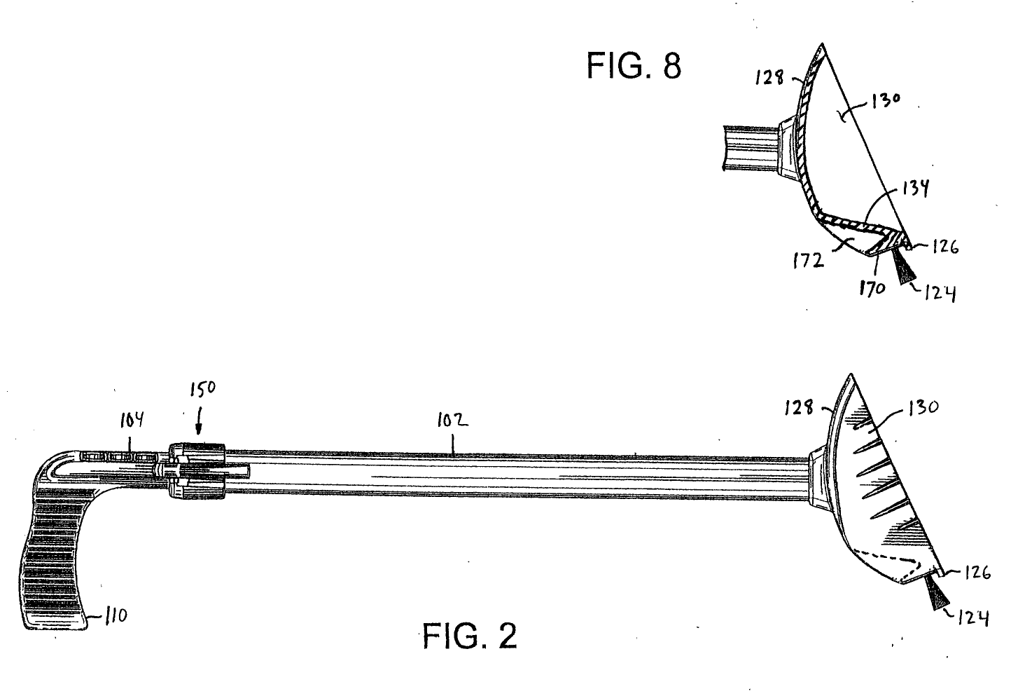

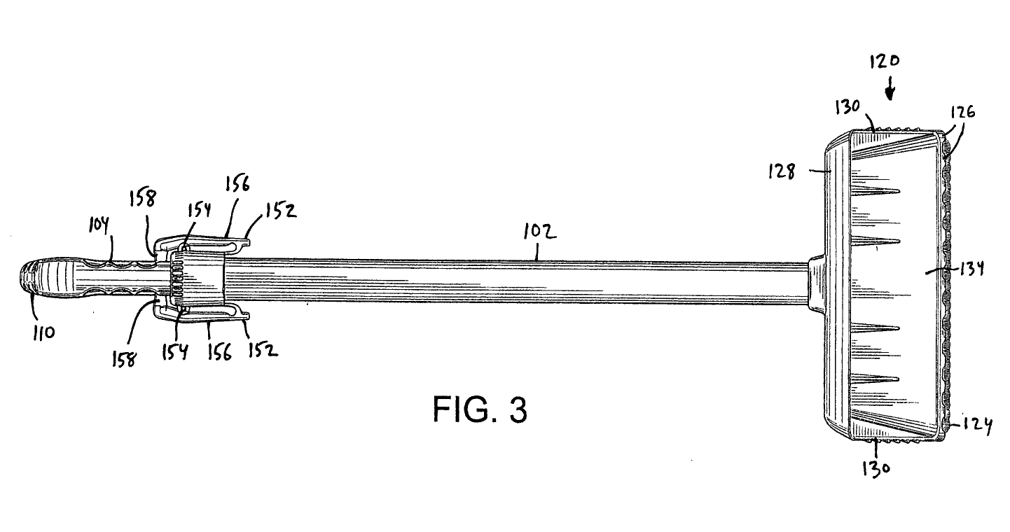

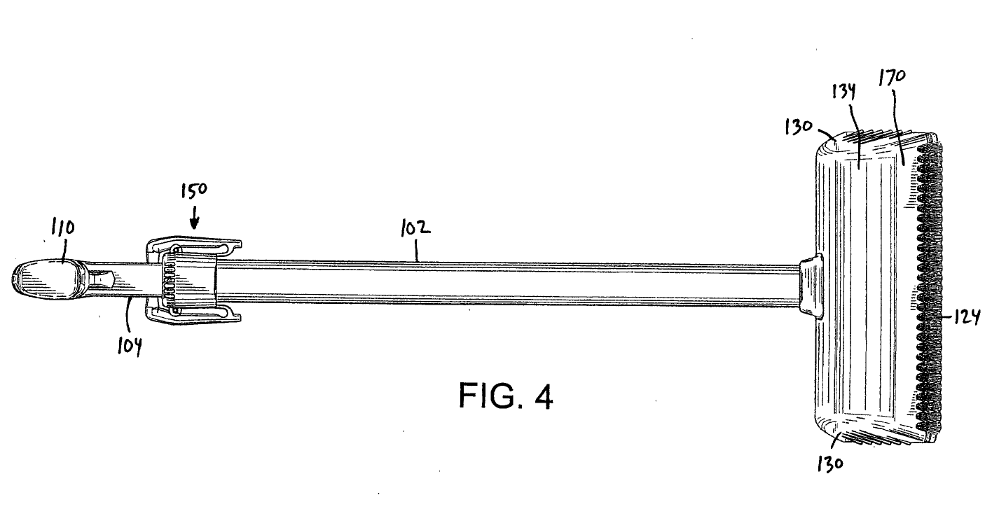

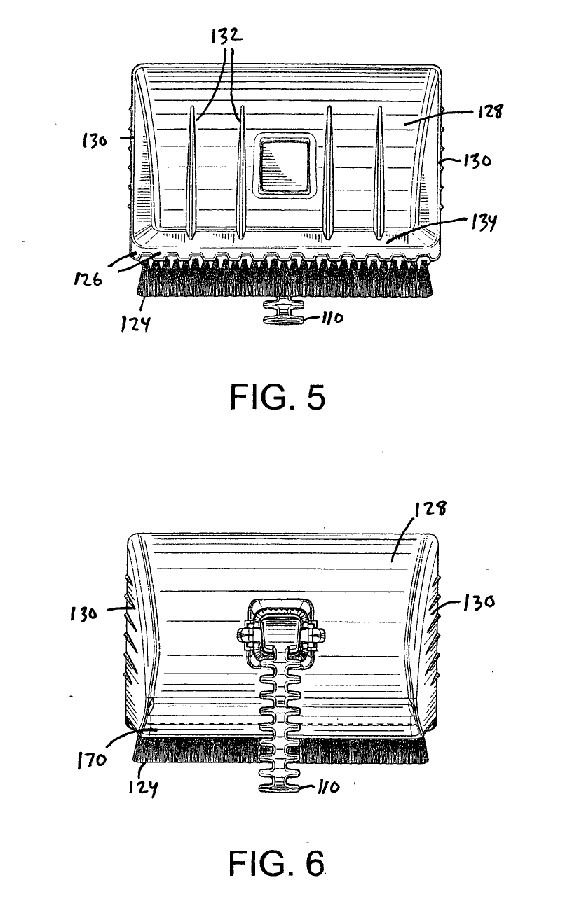

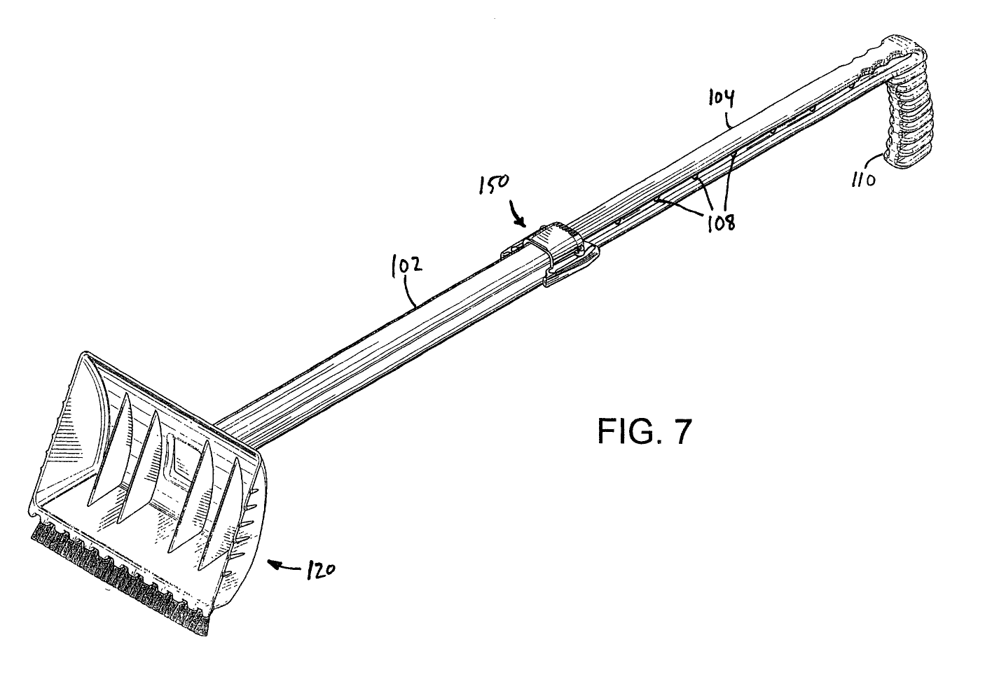

A first embodiment of the snow removal tool of the present invention is shown in FIGS. 1-8, of which FIG. 1 is a top, front, left perspective view with the handle in a first configuration, FIG. 2 is a right side elevational view, FIG. 3 is a top plan view, FIG. 4 is a bottom plan view, FIG. 5 is a front elevational view, FIG. 6 is a rear elevational view, FIG. 7 is a top, front, left perspective view with the handle in a second configuration, and FIG. 8 is a cross-section of the head. The snow removal tool of FIGS. 1-8 includes an elongated handle 100, a head 120 at one end of handle 100, and a grip 110 at the other end of handle 100.

In accordance with the present invention, the head of the snow removal tool is adapted to move material such as snow in a direction generally parallel to the handle of the snow removal tool when the snow removal tool is translated in a direction generally parallel to the handle. To this end, the embodiment of FIGS. 1-8 includes a head 120 having a plow 122. Plow 122 extends generally to handle 100, i.e., plow 122 has a projection onto a plane that is perpendicular to handle 100 which defines an area that will be swept out as the snow removal tool is translated in a direction parallel to its handle. Plow 122 shown in FIGS. 1-8 includes a rear portion 128, a lower portion 134, and end portions 130 which stiffen plow 122 and inhibit snow from being pushed aside laterally as the tool is pushed forward.

Plow 122, when viewed from the side opposite handle 100, as in FIG. 1, has a portion which is generally concave. This concave portion of plow 122 engages snow when the snow removal tool is pushed, i.e., translated in a direction generally parallel to handle 100 with head 120 leading. This concave portion of plow 122 thus acts as a forward plow, i.e., a plow that functions when the snow removal tool is pushed in the forward direction.

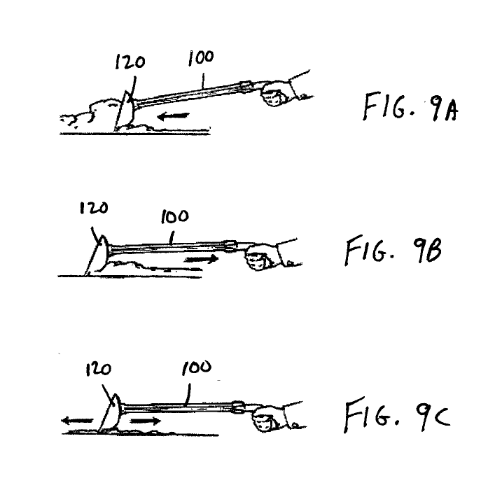

The snow removal tool of FIGS. 1-8 also includes a rearward-facing plow portion. Plow 122, when viewed from the side on which handle 100 is disposed, has a portion which is generally concave. The rearward-facing plow portion is most easily seen in the cross-sectional view of head 120 in FIG. 8, and is formed by lip 170, lower portion 134, and rear portion 128 of plow 122; portions 172 of sides 130 inhibit snow from being pushed aside laterally as the tool is pulled rearward. This concave portion of plow 122 engages snow when the snow removal tool is pulled, i.e., translated in a direction generally parallel to handle 100 with head 120 trailing. This concave portion of plow 122 thus acts as a rearward plow, i.e., a plow that functions when the snow removal tool is pulled in the rearward direction, as illustrated in FIG. 9B.

The snow removal tool of FIGS. 1-8 is adapted to remove snow from a surface both when the tool is both pushed by a user and when the tool is pulled by a user. Thus the snow removal tool may be employed using a sawing motion, as illustrated in FIG. 9C, and snow will be cleared from a surface on both forward, pushing strokes and rearward, pulling strokes.

The edge of plow 122 may be provided with “teeth” 126 to aid in breaking an icy crust of snow to be removed. After the bulk of a snow covering is removed from a surface by plow 122, remaining snow may be removed by brushing the surface using bristles 124. Bristles 124 can help avoid the snow removal tool causing damage to the surface being cleared of snow, and can reduce friction during clearing of such snow. A head 120 that includes bristles 124 is preferred, but bristles 124 may be omitted if plow 122 is made of a material which will not damage a surface of being cleared of snow, and plow 122 is desirably constructed of such a material in any event. Bristles 124 are desirably relatively short compared to the height of 122; their purpose is primarily to remove a vestigal dusting of snow. Longer bristles tend to be flexible, and might bend as the tool is moved, assuming a bowed shape tending to push the head away from the surface to be cleared. Plow 122 is desirably made of molded plastic, for example, “rubberized” polypropylene. Ribs 132 provide additional stiffening for plow 122.

The handle of a snow removal tool in accordance with the present invention is desirably adjustable in length, so that it may be extended to provide a long reach when clearing snow, and may be collapsed for convenience in storing or transporting the tool. To this end, handle 100 of the embodiment shown in FIGS. 1-8 includes telescoping handle portions 102 and 104 and locking mechanism 150 to maintain handle portions 102 and 104 in a desired relative position. As can be seen FIG. 7, handle portion 104 includes holes 108. As can be seen in FIG. 3, locking mechanism 150, which is secured to handle portion 102, includes a pair of projections 158 which are urged toward handle portion 104 by spring members 156. Pressing the ends 152 of spring members 156 inwardly causes spring members 156 to pivot around pivot members 154, thereby causing projections 158 to be withdrawn from engagement with a hole 108. This permits handle portion 104 to slide freely with respect to handle portion 102 for adjustment to a desired length; releasing ends 152 permits projections 158 to engage another hole 108 to secure handle portions 102 and 104 to one another at the desired length.

Grip 110 extends generally perpendicular to handle 100, in the manner of a pistol grip, and facilitates application of force to the handle in a direction generally parallel to handle 100. Grip 110 and handle portion 104 may be made of a plastic material such as polyethylene and may be molded together as a single part. Grip 110 and extendable handle 100 enable snow to be cleared from difficult-to-reach surfaces such as the tops of sport-utility vehicles “SUV's.”

The shape of head 120 enables the snow removal tool to be used to clear snow from other areas, such as the ground under a vehicle body or around its tires.

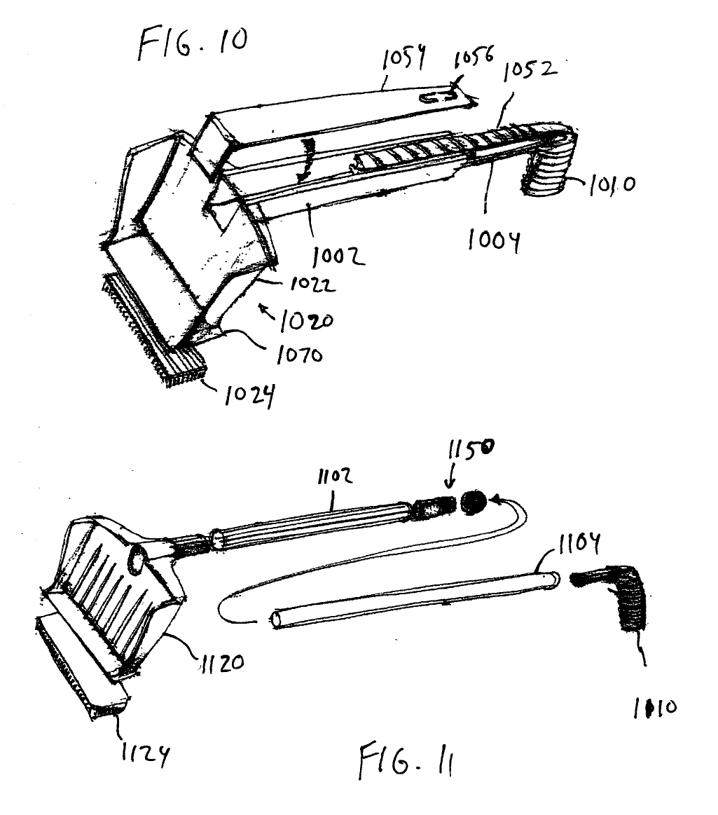

It will be understood that other plow shapes, other handle structures, and other grip shapes may be employed in snow removal tools according to the present invention. FIGS. 10-14 illustrate other embodiments of snow removal tools according to the present invention.

FIG. 10 is a perspective view of a second embodiment of a snow removal tool according to the present invention. The tool of FIG. 10 includes a head 1020 having a forward plow portion 1022 and a rearward plow portion 1070. Handle portion 1004, to which handle 1010 is secured, includes detents 1052 which engage ratchet mechanism 1056 in cover 1054 of handle portion 1002 to enable the handle length to be adjusted. Brush 1024 may be secured to plow 1022 by adhesive, snaps, staples, or the like.

The snow removal tool of FIG. 11 includes a twist-lock mechanism 1150 enabling telescoping tubes 1102 and 1104 to be loosened, adjusted to provide the desired handle length, and then tightened. Handle 1110 is secured to tube 1104, and plow 1120, which has brush 1124 secured to its lower edge, is secured to tube 1102.

The snow removal tool of FIG. 12 may include a ratchet mechanism similar to that shown in FIG. 10 to enable handle portions 1202 and 1204 to be adjusted. The tool includes both a vertical grip 1210 and horizontal grips 1212. Such grips help make a conveniently oriented grip available in a wide range of orientations of the tool. Head 1220 includes forward plow portion 1222, rearward plow portion 1270, and brush 1224.

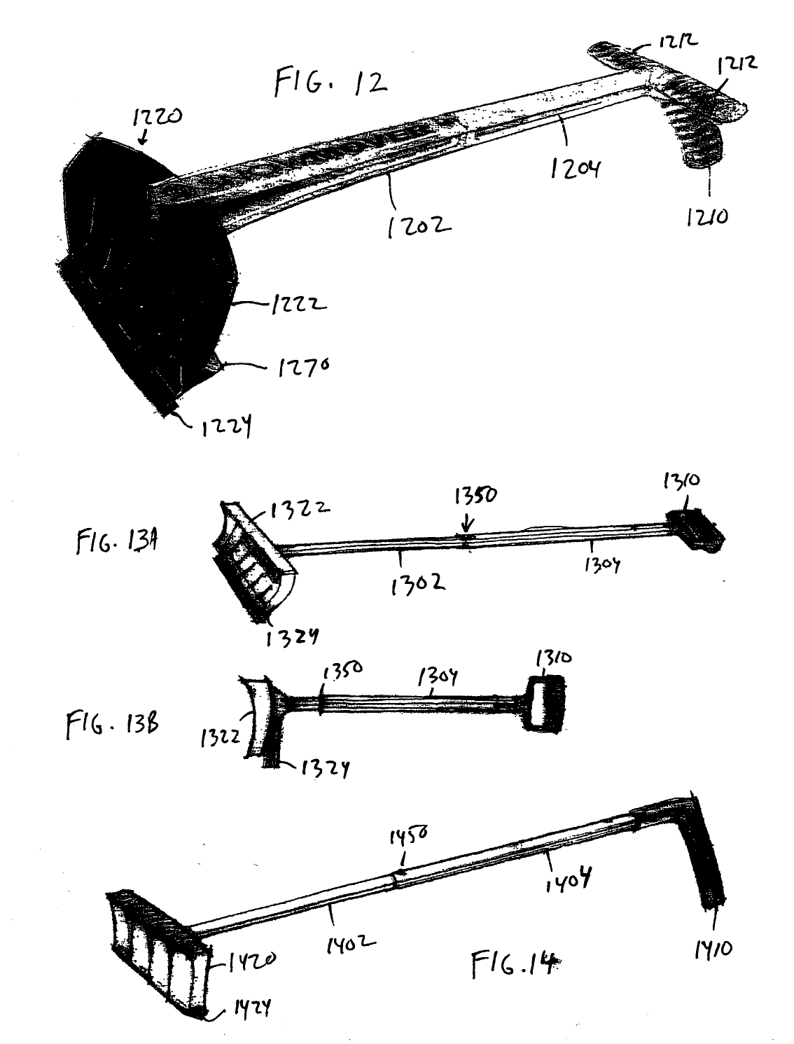

FIGS. 13A and 13B are perspective and side views, respectively, of another embodiment of a snow removal tool according to the present invention. A locking mechanism 1350 includes a spring-loaded pin that snaps into one of several available recesses to enable handle portions 1302 and 1304 to be locked at a selected handle length. A “D”-type handle 1310 is provided, and may be made rotatably adjustable. A brush 1324, having relatively long bristles, is secured to the rear of plow 1322 with a short length of its bristles extending below the lower edge of plow 1322.

The snow removal tool of FIG. 14 may include a spring-loaded pin mechanism similar to that shown in FIGS. 13A and 13B to enable handle portions 1402 and 1404 to be adjusted. The tool includes a head having a plow 1420 that is generally planar and slightly biconcave in cross-section, and that is disposed generally perpendicular to the handle so as to remove material with both pushing and pulling strokes. A brush 1424 is secured to plow 1420.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

It will be further understood that various other changes in the details, materials, and arrangements of the parts which have been described and illustrated in order to explain the nature of this invention may be made by those skilled in the art without departing from the scope of the invention as expressed in the following claims.

What is claimed is:

1. A hand tool adapted to mechanically remove material such as snow from surfaces such as automobile exterior body or window glass surfaces, the tool comprising:
a longitudinally-extending handle; and
a head that extends generally transversely to the handle and is secured to one end of the handle, the head including a forward plow portion that is adapted to move material when the tool is pushed in a direction that is generally parallel to the handle and a rear plow portion that is adapted to move material when the tool is pulled in the opposite direction.
